(19) United States
(12) Patent Application Publication
(10) Pub. No.: US 2015/0304888 A1
(43) Pub. Date: Oct. 22, 2015

(54) Methods and Nodes in a Wireless or Cellular Network

(71) Applicant: Telefonaktiebolaget L M Ericsson (publ), Stockholm (SE)

(72) Inventors: Gino Luca Masini, Stockholm (SE); Angelo Centonza, Winchester (GB); Martin Israelsson, Spanga (SE)

(73) Assignee: Telefonaktiebolaget L M Ericsson (publ)

(21) Appl. No.: 14/235,647

(22) PCT Filed: Dec. 10, 2013
(86) PCT No.: PCT/SE2013/051475

§ 371 Date: Jan. 28, 2014

Related U.S. Application Data
(60) Provisional application No. 61/808,659, filed on Apr. 5, 2013.

(51) Int. Cl. H04W 28/08; H04W 76/02

(52) U.S. Cl. CPC H04W 28/085; H04W 76/022; H04W 88/16

(57) ABSTRACT

A method in a first network node (110) for managing a radio access bearer between a local gateway (122) and a user equipment (130). The user equipment (130) is served by a second network node (120). The method comprises the step of sending (402) a first message to the second network node. The first message comprises an indication to set up the radio access bearer to be offloaded through a Selective Internet Protocol Traffic Offload, SIPTO, gateway as the local gateway. The first message comprises a Correlation Identifier, ID, Information Element, IE.

### TECHNICAL FIELD

Embodiments herein relate to a first and a second network node, and methods therein. In particular they relate to managing a radio access bearer between a local gateway and a user equipment served by the second network node.

### BACKGROUND

According to current 3rd Generation Partnership Project (3GPP) standards, it is possible since Release 10 to support local traffic routing through a Local Gateway (L-GW), co-located with a Home Evolved Universal Terrestrial Radio Access Network Node B (HeNB). This functionality is known as Local Internet Protocol Access (LIPA). In Release 12, support will be added to selectively offload Internet Protocol (IP) traffic at the local network, with a functionality known as Selective IP Traffic Offload at the Local Network (SIPTO@LN), which may require a L-GW co-located in the Evolved Universal Terrestrial Radio Access Network (E-UTRAN) Node B (eNB) or HeNB. The two functionalities LIPA and SIPTO@LN are more or less independent of one another and may operate on different E-UTRAN Radio Access Bearers (E-RABs), although they may be active at the same time and employed in the same Radio Access Network (RAN) node. Currently existing signaling between RAN and core network, e.g. using S1 Application Protocol (S1AP) and Radio Access Network Application Part (RANAP), only supports LIPA.

LIPA breakout may be performed using the architecture shown in FIG. 1, see also TR 23.829 Release 10, Section 4.1 and 3GPP TS 36.300 Release 11, Section 4.6.5. Such architecture enables the routing of IP traffic from the User Equipment (UE) through the LIPA L-GW, co-located with the HeNB, for local access into the residential/enterprise network, without the need to go through the backhaul into the core network and back.

LIPA may be enabled through a UE-supplied Access Point Name (APN) and it may be triggered on a per-E-RAB basis by the UE, according to the user's interest in the service.

Using an architecture which is conceptually similar to the one in FIG. 1, Selective IP Traffic Offload (SIPTO) breakout may be used to enable Internet access through a local gateway without going to the operator's core network and back. Similarly to LIPA, SIPTO breakout is close to the UE's point of attachment to the access network, but unlike LIPA, UE mobility may be supported, so the breakout point may be “at or above RAN”, see also 3GPP TR 23.829 Release 11, Sec. 4.1.2.

Unlike LIPA, which is defined only for H(e)NBs, SIPTO may be applicable to both (e)NBs and H(e)NBs. If the SIPTO traffic offload is performed at the local network, it is defined as SIPTO@LN. Unlike LIPA, SIPTO, and SIPTO@LN, may be enabled through an APN in the Home Subscriber Server (HSS) and it is triggered by the operator. See also 3GPP TS 23.401 Sections 5.3.4.1 and 5.7.2.

LIPA and SIPTO, comprising SIPTO@LN, functionalities are independent, and they may operate on different E-RABs. In some cases, the same traffic may not be routed to the residential or enterprise network for local access and be offloaded for Internet access at the same time. Nevertheless, LIPA and SIPTO functionalities may be active at the same time and in the same HeNB.

Current S1AP signaling only supports LIPA. A Correlation Identifier (ID) Information Element (IE) is defined as “the GTP Tunnel Endpoint Identifier or GRE key to be used for a user plane transport between eNB and the L-GW described in TS 23.401”, see also 3GPP TS 36.413 Release 11, Section 9.2.1.80. This IE is optionally signaled by the Mobility Management Entity (MME) on a per-E-RAB basis in the E-RAB SETUP REQUEST and in the INITIAL CONTEXT SETUP REQUEST messages. In this way the co-located L-GW “knows” which E-RAB(s) to route directly. In addition, a GW Transport Layer Address IE, containing the IP address of the LIPA L-GW, may optionally be signaled by the RAN to the MME in the INITIAL UE MESSAGE and in the UPLINK NAS TRANSPORT messages, see also 3GPP TS 36.413 Release 11. , Sections 8.6.2.1 and 8.6.2.3. In this way, the MME knows that LIPA has been triggered by the UE and the MME may be informed of the IP address of the L-GW for possible charging functions and communication via S5 interface.

There is no way for the MME to signal to the RAN node to indicate that an E-RAB should be offloaded through the SIPTO L-GW instead of through the LIPA L-GW. This may be particularly limiting in the case that the RAN node incorporates both types of L-GWs.

### SUMMARY

It is therefore an object of embodiments herein to improve the way of managing offloading in a wireless communications network.

According to a first aspect of embodiments herein, the object is achieved by a method in a first network node for managing a radio access bearer between a local gateway and a user equipment. The user equipment is served by a second network node. The method comprises the step of sending a first message to the second network node. The first message comprises an indication to set up the radio access bearer to be offloaded through a Selective Internet Protocol Traffic Offload, SIPTO, gateway as the local gateway. The first message comprises a Correlation Identifier, ID, Information Element, IE.

According to a second aspect of embodiments herein, the object is achieved by a method in a second network node for managing a radio access bearer between a local gateway and a user equipment. The user equipment is served by the second network node. The method comprises the step of receiving a first message from a first network node. The first message comprises an indication to set up the radio access bearer to be offloaded through a Selective Internet Protocol Traffic Offload, SIPTO, gateway as the local gateway. The first message comprises a Correlation Identifier, ID, Information Element, IE.

According to a third aspect of embodiments herein, the object is achieved by a first network node for managing a radio access bearer between a local gateway and a user equipment. The user equipment is served by a second network node. The first network node comprises a sending unit adapted to send a first message to the second network node. The first message comprises an indication to set up the radio access bearer to be offloaded through a Selective Internet Protocol Traffic Offload, SIPTO, gateway as the local gateway. The first message comprises a Correlation Identifier, ID, Information Element, IE.

According to a third aspect of embodiments herein, the object is achieved by a second network node for managing a radio access bearer between a local gateway and a user equipment. The user equipment is served by the second network node. The second network node comprises a receiving unit adapted to receive a first message from a first network node. The first message comprises an indication to set up the radio access bearer to be offloaded through a Selective Internet Protocol Traffic Offload, SIPTO, gateway as the local gateway. The first message comprises a Correlation Identifier, ID, Information Element, IE.

An advantage of embodiments described herein, is that it is possible to support LIPA and SIPTO functionality operating over different radio access bearers in the same network node at the same time, without ambiguity in the signaling.

### BRIEF DESCRIPTION OF THE DRAWINGS

The solution will now be described in more detail by means of exemplary embodiments and with reference to the accompanying drawings, in which:

FIG. 1 illustrates a communication scenario where LIPA breakout may be employed in a residential or enterprise IP network.

FIG. 1a illustrates a management system architecture.

FIG. 2 illustrates an overall E-UTRAN architecture with deployed HeNB-GW.

FIG. 3 is a schematic block diagram illustrating embodiments of a wireless communications network.

FIG. 4 is a flow chart illustrating embodiments of a method in a first network node.

FIG. 5 is a flow chart illustrating embodiments of a method in a second network node.

FIG. 6 is a block diagram illustrating an example of a first and a second network node in more detail.

FIG. 7 illustrates a possible splitting a Correlation ID range.

FIG. 8 illustrates a possible E-RAB setup procedure, between the MME and the eNB, or HeNB.

FIG. 9 illustrates an Initial context setup procedure, between the MME and the eNB, or HeNB.

### DETAILED DESCRIPTION

In this disclosure, it is described a possible way to signal from the MME to the RAN node that an E-RAB should be offloaded through the SIPTO L-GW instead of through the LIPA L-GW. A mechanism similar to the LIPA Correlation ID may be used, except that it may apply to the SIPTO functionality in such a way that it is possible for the same RAN node to support both functionalities at the same time without any ambiguity or misunderstanding in signaling between the RAN node and the core network.

Although some possible embodiments are described in detail below for the E-UTRAN case, S1AP signaling between the (H)eNB and the MME, the embodiments described herein may also be applied for the UTRAN case.

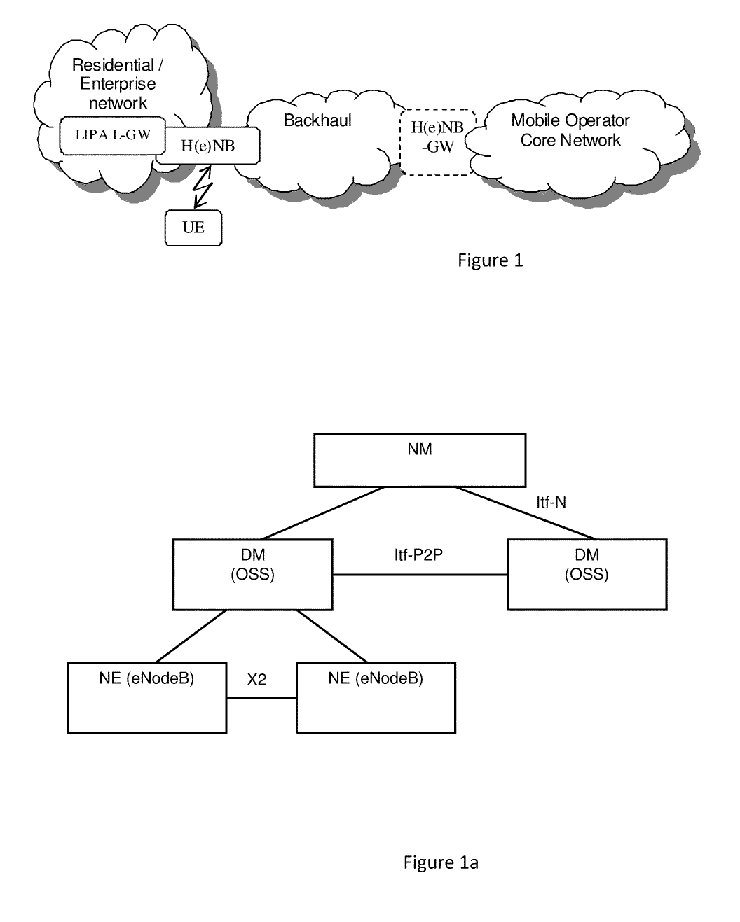

A management system that may be employed in embodiments herein is shown in FIG. 1a. Node elements (NE), also referred to as eNodeB, are managed by a domain manager (DM), also referred to as the operation and support system (OSS). A DM may further be managed by a network manager (NM). Two NEs are interfaced by X2, whereas the interface between two DMs is referred to as Itf-P2P. The management system may configure the network elements, as well as receive observations associated to features in the network elements. For example, DM observes and configures NEs, while NM observes and configures DM, as well as NE via DM.

In embodiments described herein, it may be further assumed that any function that automatically optimizes NE parameters may in principle execute in the NE, DM, or a Network Management System, NMS. Such features are referred to as Self-Organizing Network (SON) features.

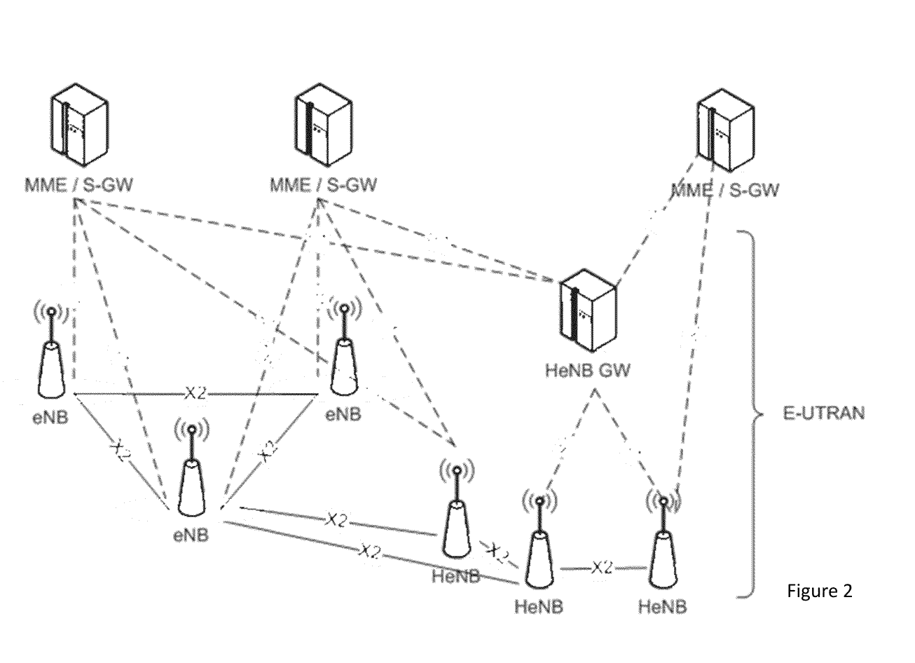

An overall E-UTRAN architecture is shown in FIG. 2, see also 3GPP TS 36.300 Release 11, Section 4.6.1.

An eNB may comprise a L-GW functionality for SIPTO, and a HeNB may comprise a L-GW functionality for SIPTO and/or a L-GW functionality for LIPA. A HeNB which comprises LIPA functionality has been represented with its S5 interface. The optional HeNB-GW is shown, although it may not be relevant to embodiments described herein.

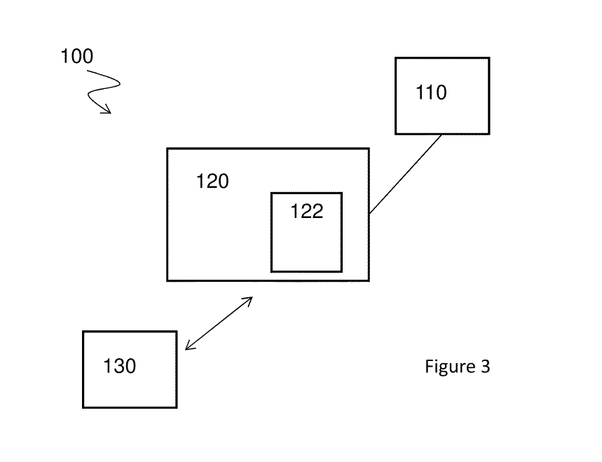

FIG. 3 depicts an example of a wireless communications network 100.The wireless communications network 100 may be referred to as a wireless or a cellular network e.g. based on any of 3rd Generation, Universal Mobile Telecommunications System (UMTS), Wideband Code Division Multiple Access (WCDMA), High Speed Packet Access (HSPA) and 4th Generation (4G), Evolved Packet System (EPS), Long Term Evolution (LTE), Long Term Evolution Advanced (LTE-A), or may be referred to as a wireless communication network such as an LTE, WCDMA, Global System for Mobile Communications (GSM) network, any 3GPP cellular network, Worldwide Interoperability for Microwave Access (Wimax), or any cellular network or system.

The wireless communications network 100 comprises a plurality of network nodes whereof two are depicted in FIG. 3. One of those is a first network node 110. The first network node 110 may e.g. be a core network node, a Mobility Management Entity (MME), Operation and Maintenance (OAM), node or the like.

The other network node depicted in FIG. 3 is a second network node 120 . The second network node 120 may be a radio network node, a radio base station, a base station, a Radio Network Controller (RNC), an eNodeB, a NodeB or the like.

The second network node 120 may comprise, or be co-located with one or more gateways, such as e.g. a local gateway 122. The local gateway 122 may be a gateway such as a SIPTO gateway, a SIPTO@LN Local Gateway (L-GW) also referred to as a SIPTO@LN with Local Gateway (L-GW), a LIPA gateway (LIPA L-GW). Hence, in some embodiments, the second network node 120 supports radio access bearers for both LIPA operation, SIPTO operation, and maybe also SIPTO at Local Network LN.

A user equipment 130 operates in the wireless communications network 100. The user equipment 130 may be any terminal or device capable of communicating with the second network node 120 over radio channels

The user equipment 130 may e.g. be a wireless device, a mobile wireless terminal or a wireless terminal, a mobile phone, a computer such as e.g. a laptop, a Personal Digital Assistants (PDAs) or a tablet computer, sometimes referred to as a surf plate, with wireless capability, or any other radio network units capable to communicate over a radio link in a wireless communications network.

The first network node 110 may be a core network node, a Mobility Management Entity (MME), Operation and Maintenance (OAM) node or the like.

The second network node 120 may be a radio network node, a radio base station, a base station, a Radio Network Controller (RNC), an eNB, a NodeB or the like.

The radio access bearer may be a RAB, an Evolved-RAB (E-RAB) or the like.

The messages with names in capital letters are known from standard specifications of the 3GPP.

It should be noted that the above embodiments may be used one at a time or together in any combination of two or more embodiments whenever suitable.

Thus, in this disclosure, the terms base station, eNB and network node may be used interchangeably to represent a node of a wireless or cellular network which node is capable of communicating with wireless UEs over radio channels. Further, the term UE is used here to represent any terminal or device capable of communicating with the above node over radio channels.

The disclosure is related to wireless or cellular networks, e.g. based on any of 3G/UMTS/WCDMA/HSPA and 4G/EPS/LTE/LTE-A. Furthermore, embodiments described in this disclosure may be used for improving efficiency and/or for reducing usage of resources in the wireless or cellular network.

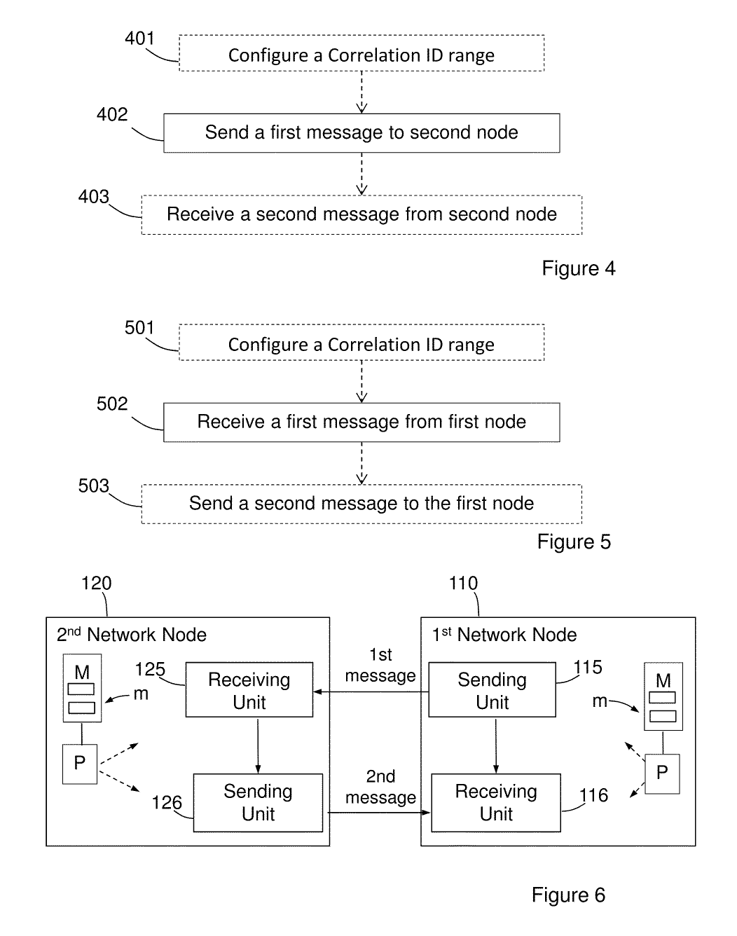

Example of embodiments of a method in the first network node 110 for managing a radio access bearer between the local gateway 122 and the user equipment 130 served by the second network node 120, will now be described with reference to a flowchart depicted in FIG. 4. The method comprises the following actions, which actions may be taken in any suitable order. Dashed lines of boxes in FIG. 4 indicate that these action are not mandatory. According to an example scenario the first network node 110 is preparing to offload IP traffic at a local network via the local gateway 122.

Action 401

In some of the embodiments herein, such as in the first embodiment described below, it is advantageous to configure or pre-configure the first network node 110. Thus, in these embodiments, such as the first embodiment described below, the first network node 110 may configure a Correlation ID range comprising a first sub-range for identifications relating to SIPTO and a second sub-range for identifications relating to Local Internet Protocol Access, LIPA. A potential advantage of these embodiments is that they require no change to previously known signaling/message implementation, since an already used IE is signaled, and no new IE needs to be added to the message.

Action 402

To inform the second network node 120 that IP traffic shall be offloaded via the local gateway 122, the first network node 110 sends a first message to the second network node 120. The first message comprises an indication to set up the radio access bearer to be offloaded through a SIPTO gateway as the local gateway. The first message comprises a Correlation ID IE.

The Correlation ID IE is an IE which is used for signal certain messages in order to trigger LIPA offload through a local gateway in cases where the offload shall be performed via a LIPA gateway. According to embodiments herein, the Correlation ID IE is used to trigger SIPTO offload through a local gateway 122. Thus the Correlation ID IE may be used both for LIPA offload and for SIPTO offload.

In some embodiments, such as the third embodiment described below, the Correlation ID IE is a SIPTO Correlation ID IE. In these embodiments the indication is represented by a SIPTO Correlation ID, comprised in the SIPTO Correlation ID IE. A potential advantage of these embodiments is that it is not necessary to plan and pre-configure different Correlation ID values or ranges beforehand for either functionality, since explicit signaling is introduced. The whole range of possible values for the Correlation ID may be reused for both LIPA and SIPTO functionalities at the same time. A further advantage of these embodiments may be that the SIPTO Correlation ID is completely independent from the Correlation ID, so in principle it may even be defined over a completely different range if required.

In some alternative embodiments, such as the second embodiment described below, the indication is represented by a SIPTO flag comprised in a SIPTO flag IE in the first message. A potential advantage of these embodiments is that it is not necessary to plan and pre-configure different Correlation ID values or ranges beforehand for either functionality, since explicit signaling is introduced. The whole range of possible values for the Correlation ID may be reused for both LIPA and SIPTO functionalities at the same time.

In some alternative embodiments, such as the first embodiment described below, wherein action 401 has been performed, the indication is represented by a Correlation ID from the first sub-range, comprised in the Correlation ID IE. A mentioned above, a potential advantage of these embodiments is that they require no change to previously known signaling/message implementation, since an already used IE is signaled, and no new IE needs to be added to the message.

In some embodiments, the first message is represented by an INITIAL CONTEXT SETUP REQUEST message and/or an E-RAB SETUP REQUEST message.

The embodiments in this action will be described further in detail below.

Action 403

In some embodiments, the first network node 110 receives a second message from the second network node 120. So called Class 1 procedures comprise a request and a response/failure message. The second message indicates successful set up of the radio access bearer.

In some embodiments, the second message is represented by an E-RAB SETUP RESPONSE message and/or an INITIAL CONTEXT SETUP RESPONSE message.

Example of embodiments of a method in the second network node 120 for managing a radio access bearer between the local gateway 122 and the user equipment 130 served by the second network node 120, will now be described with reference to a flowchart depicted in FIG. 5. The method comprises the following actions, which actions may be taken in any suitable order. Dashed lines of boxes in FIG. 5 indicate that these action are not mandatory.

Action 501

In some embodiments, such as the first embodiment described below, the second network node configures a Correlation ID range comprising a first sub-range for identifications relating to SIPTO and a second sub-range for identifications relating to LIPA. An advantage of these embodiment is that in them, the same Correlation ID IE is used for LIPA and SIPTO, with different value ranges for each functionality.

Action 502

The second network node 120 receives a first message from the first network node 110. The first message comprises an indication to set up the radio access bearer to be offloaded through a Selective Internet Protocol Traffic Offload, SIPTO, gateway as the local gateway. The first message comprises a Correlation ID IE.

In some embodiments, such as the third embodiment described below, the Correlation ID IE is a SIPTO Correlation ID IE. In these embodiments the indication is represented by a SIPTO Correlation ID, comprised in the SIPTO Correlation ID IE.

In some alternative embodiments, such as the second embodiment described below, the indication is represented by a SIPTO flag comprised in a SIPTO flag IE in the first message.

In some alternative embodiments, such as the first embodiment described below, wherein action 501 has been performed, or wherein the first network node 110 has configured a Correlation ID range comprising a first sub-range for identifications relating to SIPTO and a second sub-range for identifications relating to LIPA, the indication is represented by a Correlation ID from the first sub-range, comprised in the Correlation ID IE.

In some embodiments, the first message is represented by an INITIAL CONTEXT SETUP REQUEST message and/or an E-RAB SETUP REQUEST message

Action 503

In some embodiments, the second network node 120 sends a second message to the first network node 110, indicating successful set up of the radio access bearer.

In some embodiments the second message is represented by an E-RAB SETUP RESPONSE message and/or an INITIAL CONTEXT SETUP RESPONSE message.

Example of embodiments of a first network node 110 for managing a radio access bearer between a local gateway 122 and a user equipment 130 served by a second network node 120, will now be described with reference to FIG. 6.

The first network node comprises a sending unit 115 adapted to send to the second network node 120 a first message comprising an indication to set up the radio access bearer to be offloaded through a Selective Internet Protocol Traffic Offload, SIPTO, gateway as the local gateway 122. The first message comprises a Correlation Identifier, ID, Information Element, IE.

In some embodiments, such as the third embodiment described below, the Correlation ID IE is a SIPTO Correlation ID IE. Then the indication is represented by a SIPTO Correlation ID, comprised in the SIPTO Correlation ID IE.

In some alternative embodiments, such as the second embodiment described below, the indication is represented by a SIPTO flag comprised in a SIPTO flag IE in the first message.

In some embodiments, such as the first embodiment described below, the first network node comprises a processor P arranged to configure a Correlation ID range comprising a first sub-range for identifications relating to SIPTO and a second sub-range for identifications relating to Local Internet Protocol Access, LIPA. In these embodiments, the indication is represented by a Correlation ID from the first sub-range, comprised in the Correlation ID IE.

In some embodiments, the first message is represented by an INITIAL CONTEXT SETUP REQUEST message and/or an E-RAB SETUP REQUEST message.

In some embodiments, the first network node further comprises a receiving unit 116 adapted to receive a second message from the second network node 120, indicating successful set up of the radio access bearer.

In some embodiments, the second message is represented by an E-RAB SETUP RESPONSE message and/or an INITIAL CONTEXT SETUP RESPONSE message.

Example of embodiments of a second network node 120 for managing a radio access bearer between a local gateway 122 and a user equipment 130 served by the second network node 120, will now be described with reference to FIG. 6.

The second network node 120 comprises a receiving unit 126 adapted to receive from a first network node 110, a first message comprising an indication to set up the radio access bearer to be offloaded through a Selective Internet Protocol Traffic Offload, SIPTO, gateway as the local gateway 122. The first message comprises a Correlation Identifier, ID, Information Element, IE.

In some embodiments, such as the third embodiment described below, the Correlation ID IE is a SIPTO Correlation ID IE. Then, the indication is represented by a SIPTO Correlation ID, comprised in the SIPTO Correlation ID IE.

In some alternative embodiments, such as the second embodiment described below, the indication is represented by a SIPTO flag comprised in a SIPTO flag IE in the first message.

In some embodiments, such as the first embodiment described below, the second network node comprises a processor P arranged to configure a Correlation ID range comprising a first sub-range for identifications relating to SIPTO and a second sub-range for identifications relating to Local Internet Protocol Access, LIPA. In these embodiments, the indication is represented by a Correlation ID from the first sub-range, comprised in the Correlation ID IE.

In some embodiments, the first message is represented by an INITIAL CONTEXT SETUP REQUEST message and/or an E-RAB SETUP REQUEST message.

In some embodiments, the second network node further comprises a sending unit adapted to send a second message to the first network node 110, indicating successful set up of the radio access bearer.

In some embodiments, the second message is represented by an E-RAB SETUP RESPONSE message and/or an INITIAL CONTEXT SETUP RESPONSE message.

Various details of some possible embodiments are discussed below.

As mentioned above, the overall E-UTRAN architecture is shown in FIG. 2, see also 3GPP TS 36.300 Release 11, Section 4.6.1. An eNB may comprise a L-GW functionality for SIPTO, and a HeNB may comprise a L-GW functionality for SIPTO and/or a L-GW functionality for LIPA. A HeNB which comprises LIPA functionality has been represented with its S5 interface. The S5 interface provides the functionality associated with creation, modification and deletion of bearers for user equipments connected to the network. The optional HeNB-GW is shown, although it may not be relevant to embodiments described herein.

Splitting the S1AP Correlation ID IE Range

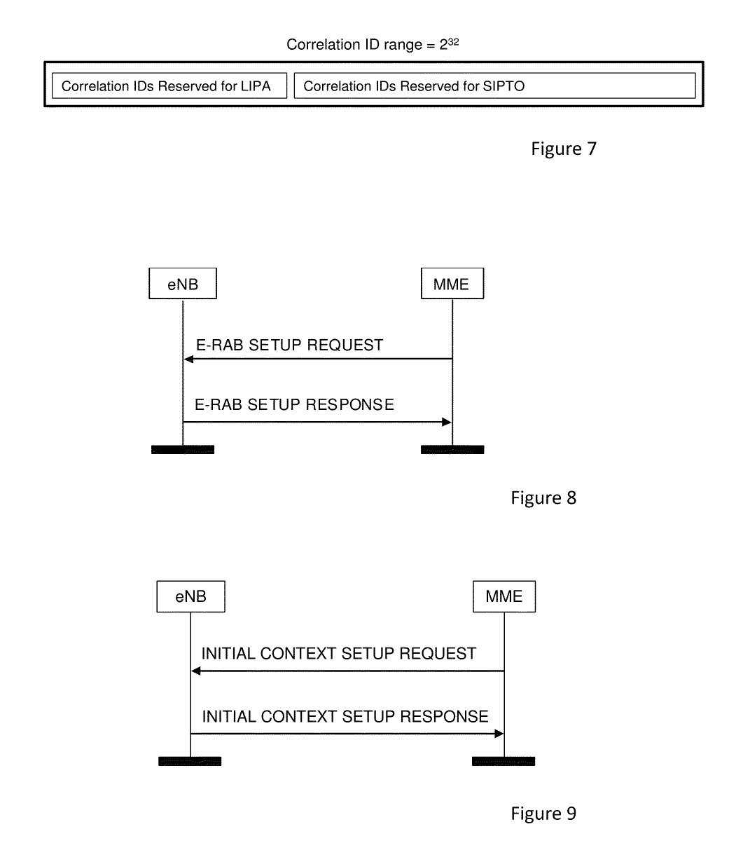

In a first possible embodiment, SIPTO is supported by reusing the current S1AP IEs. For S1AP IEs, see 3GPP TS 36.413 Release 11, Section 9.2.1.80. The current Correlation ID IE, as defined in 3GPP TS 36.413 Release 11, is signaled between a first network node, such as an MME, and a second network node, such as an HeNB or eNB, both for E-RABs that shall be routed through the LIPA L-GW, and for E-RABs that shall be routed through the SIPTO L-GW. In order to differentiate between the two cases the Correlation ID range may be split in two sub-ranges, where Correlation IDs in one sub-range may be used for SIPTO and those in the other sub-range are used for LIPA, see FIG. 7. Both the MME and the HeNB or eNB may be pre-configured with the information about which values for the Correlation ID are reserved for each functionality. This corresponds to actions 401 and 501 described above. The configuration may occur via other sub-systems such as the Operation and Maintenance (OAM) system. A potential advantage of this procedure is that no change to current S1AP signaling is necessary.

The Correlation ID IE may be defined as a 4-octet bit string: given the large number of available Correlation IDs (2³²), this option does not introduce significant limitations on the deployment. Moreover, it may in some embodiments be possible to modify this configuration if the LIPA vs. SIPTO “mix” of services should change significantly in time ,and in fact, such “mix” is expected not to be subject to dramatic changes in short periods of time. It is also likely that the operator knows this “mix” in advance, so it may be feasible to plan and semi-statically configure such a partitioning in this way.

Adding a New SIPTO Flag IE

Also in a further possible second embodiment, SIPTO may be supported by reusing the current S1AP IEs, but a new SIPTO Flag IE may be added to the S1AP signaling so that the relevant E-RAB identified by the corresponding Correlation ID IE is flagged as either LIPA or SIPTO. A possible way to signal such an IE in the S1AP INITIAL CONTEXT SETUP REQUEST and E-RAB SETUP REQUEST messages is underlined in Table 1 and Table 2, respectively. For the INITIAL CONTEXT SETUP REQUEST message, se also FIG. 8. For the E-RAB SETUP REQUEST message, see FIG. 9.

TABLE 1

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate Maximum | M | | 9.2.1.20 | | YES | reject |
| Bit Rate | | | | | | |
| E-RAB to Be Setup List | | 1 | | | YES | reject |
| >E-RAB to Be Setup | | 1 . . . <maxnoofE- | | | EACH | reject |
| Item IEs | | RABs> | | | | |
| >>E-RAB ID | M | | 9.2.1.2 | | — | |
| >>E-RAB Level QoS | M | | 9.2.1.15 | Includes necessary | — | |
| Parameters | | | | QoS parameters. | | |
| >>Transport Layer | M | | 9.2.2.1 | | — | |
| Address | | | | | | |
| >>GTP-TEID | M | | 9.2.2.2 | | — | |
| >>NAS-PDU | O | | 9.2.3.5 | | — | |
| >>Correlation ID | O | | 9.2.1.80 | | YES | ignore |
| >>SIPTO Flag | O | | BOOLEAN | Set to “true” if | YES | ignore |
| | | | | the Correlation ID | | |
| | | | | IE refers to SIPTO | | |
| | | | | functionality | | |
| UE Security Capabilities | M | | 9.2.1.40 | | YES | reject |
| Security Key | M | | 9.2.1.41 | The KeNB is | YES | reject |
| | | | | provided after the | | |
| | | | | key-generation in | | |
| | | | | the MME, see TS | | |
| | | | | 33.401 [15]. | | |
| Trace Activation | O | | 9.2.1.4 | | YES | ignore |
| Handover Restriction List | O | | 9.2.1.22 | | YES | ignore |
| UE Radio Capability | O | | 9.2.1.27 | | YES | ignore |
| Subscriber Profile ID for | O | | 9.2.1.39 | | YES | ignore |
| RAT/Frequency priority | | | | | | |
| CS Fallback Indicator | O | | 9.2.3.21 | | YES | reject |
| SRVCC Operation | O | | 9.2.1.58 | | YES | ignore |
| Possible | | | | | | |
| CSG Membership Status | O | | 9.2.1.73 | | YES | ignore |
| Registered LAI | O | | 9.2.3.1 | | YES | ignore |
| GUMMEI | O | | 9.2.3.9 | This IE indicates | YES | ignore |
| | | | | the MME serving | | |
| | | | | the UE. | | |
| MME UE S1AP ID 2 | O | | 9.2.3.3 | This IE indicates | YES | ignore |
| | | | | the MME UE S1AP | | |
| | | | | ID assigned by the | | |
| | | | | MME. | | |
| Management Based MDT | O | | 9.2.1.83 | | YES | ignore |
| Allowed | | | | | | |
| Management Based MDT | O | | MDT PLMN | | YES | ignore |
| PLMN List | | | List | | | |
| | | | 9.2.1.89 | | | |

| Range bound | Explanation |
|---|---|
| maxnoofE-RABs | Maximum no. of E-RAB allowed towards one UE, the maximum |
| | value is 256. |

TABLE 2

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate Maximum | O | | 9.2.1.20 | | YES | reject |
| Bit Rate | | | | | | |
| E-RAB to be Setup List | | 1 | | | YES | reject |
| >E-RAB To Be Setup | | 1 . . . <maxnoofE- | | | EACH | reject |
| Item IEs | | RABs> | | | | |
| >>E-RAB ID | M | | 9.2.1.2 | | — | |
| >>E-RAB Level QoS | M | | 9.2.1.15 | Includes | — | |
| Parameters | | | | necessary | | |
| | | | | QoS | | |
| | | | | parameters. | | |
| >>Transport Layer | M | | 9.2.2.1 | | — | |
| Address | | | | | | |
| >>GTP-TEID | M | | 9.2.2.2 | EPC TEID. | — | |
| >>NAS-PDU | M | | 9.2.3.5 | | — | |
| >>Correlation ID | O | | 9.2.1.80 | | YES | ignore |
| >>SIPTO Flag | O | | BOOLEAN | Set to “true” | YES | ignore |
| | | | | if the | | |
| | | | | Correlation | | |
| | | | | ID IE refers | | |
| | | | | to SIPTO | | |
| | | | | functionality | | |

| Range bound | Explanation |
|---|---|
| maxnoofE-RABs | Maximum no. of E-RAB allowed towards one UE, the maximum |
| | value is 256. |

The SIPTO Flag IE may also be encoded as an ENUMERATED data type, in order to allow further expansion with additional functionality. The SIPTO Flag IE may further be encoded as “Conditional” instead of “Optional”, defining the condition for its presence as dependent on the presence of the Correlation ID IE.

With respect to the previous embodiment, in this case it may not be necessary to plan and pre-configure different Correlation ID values for LIPA and SIPTO, the whole 2³² range may be used for both functionalities at the same time.

Introducing a Dedicated IE

In a further possible third embodiment, SIPTO may be supported through a new, dedicated SIPTO Correlation ID IE. With respect to the previous embodiments, this one may offer the additional flexibility of defining the SIPTO Correlation ID over a different range of values than the existing Correlation ID: in this way, more possible SIPTO Correlation IDs could be defined than Correlation IDs or vice versa, according to the case. A possible way to signal such an IE in the S1AP INITIAL CONTEXT SETUP REQUEST and E-RAB SETUP REQUEST messages is highlighted in Table 3, Table 1 and Table 4, respectively.

TABLE 3

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate Maximum Bit | M | | 9.2.1.20 | | YES | reject |
| Rate | | | | | | |
| E-RAB to Be Setup List | | 1 | | | YES | reject |
| >E-RAB to Be Setup | | 1 . . . <maxnoofE- | | | EACH | reject |
| Item IEs | | RABs> | | | | |
| >>E-RAB ID | M | | 9.2.1.2 | | — | |
| >>E-RAB Level QoS | M | | 9.2.1.15 | Includes necessary | — | |
| Parameters | | | | QoS parameters. | | |
| >>Transport Layer | M | | 9.2.2.1 | | — | |
| Address | | | | | | |
| >>GTP-TEID | M | | 9.2.2.2 | | — | |
| >>NAS-PDU | O | | 9.2.3.5 | | — | |
| >>Correlation ID | O | | 9.2.1.80 | | YES | ignore |
| >>SIPTO Correlation | O | | 9.2.1.80 | | YES | ignore |
| ID | | | | | | |
| UE Security Capabilities | M | | 9.2.1.40 | | YES | reject |
| Security Key | M | | 9.2.1.41 | The KeNB is | YES | reject |
| | | | | provided after the | | |
| | | | | key-generation in | | |
| | | | | the MME, see TS | | |
| | | | | 33.401 [15]. | | |
| Trace Activation | O | | 9.2.1.4 | | YES | ignore |
| Handover Restriction List | O | | 9.2.1.22 | | YES | ignore |
| UE Radio Capability | O | | 9.2.1.27 | | YES | ignore |
| Subscriber Profile ID for | O | | 9.2.1.39 | | YES | ignore |
| RAT/Frequency priority | | | | | | |
| CS Fallback Indicator | O | | 9.2.3.21 | | YES | reject |
| SRVCC Operation Possible | O | | 9.2.1.58 | | YES | ignore |
| CSG Membership Status | O | | 9.2.1.73 | | YES | ignore |
| Registered LAI | O | | 9.2.3.1 | | YES | ignore |
| GUMMEI | O | | 9.2.3.9 | This IE indicates | YES | ignore |
| | | | | the MME serving | | |
| | | | | the UE. | | |
| MME UE S1AP ID 2 | O | | 9.2.3.3 | This IE indicates | YES | ignore |
| | | | | the MME UE S1AP | | |
| | | | | ID assigned by the | | |
| | | | | MME. | | |
| Management Based MDT | O | | 9.2.1.83 | | YES | ignore |
| Allowed | | | | | | |
| Management Based MDT | O | | MDT PLMN | | YES | ignore |
| PLMN List | | | List | | | |
| | | | 9.2.1.89 | | | |

| Range bound | Explanation |
|---|---|
| maxnoofE-RABs | Maximum no. of E-RAB allowed towards one UE, the maximum |
| | value is 256. |

TABLE 4

| | | | IE type and | Semantics | | Assigned |
|---|---|---|---|---|---|---|
| IE/Group Name | Presence | Range | reference | description | Criticality | Criticality |
| Message Type | M | | 9.2.1.1 | | YES | reject |
| MME UE S1AP ID | M | | 9.2.3.3 | | YES | reject |
| eNB UE S1AP ID | M | | 9.2.3.4 | | YES | reject |
| UE Aggregate Maximum Bit | O | | 9.2.1.20 | | YES | reject |
| Rate | | | | | | |
| E-RAB to be Setup List | | 1 | | | YES | reject |
| >E-RAB To Be Setup | | 1 . . . <maxnoofE- | | | EACH | reject |
| Item IEs | | RABs> | | | | |
| >>E-RAB ID | M | | 9.2.1.2 | | — | |
| >>E-RAB Level QoS | M | | 9.2.1.15 | Includes | — | |
| Parameters | | | | necessary | | |
| | | | | QoS | | |
| | | | | parameters. | | |
| >>Transport Layer | M | | 9.2.2.1 | | — | |
| Address | | | | | | |
| >>GTP-TEID | M | | 9.2.2.2 | EPC TEID. | — | |
| >>NAS-PDU | M | | 9.2.3.5 | | — | |
| >>Correlation ID | O | | 9.2.1.80 | | YES | ignore |
| >>SIPTO Correlation | O | | 9.2.1.80 | | YES | ignore |
| ID | | | | | | |

| Range bound | Explanation |
|---|---|
| maxnoofE-RABs | Maximum no. of E-RAB allowed towards one UE, the maximum |
| | value is 256. |

In this example, the SIPTO Correlation ID is defined in the same way as the Correlation ID (which is 4 octets in 3GPP TS 36.413 Release 11, yielding 2³² possible values). Since the two IEs are in principle independent of one another, it is also possible to define a different range for the SIPTO Correlation ID, according to the desired number of possible SIPTO Correlation IDs.

The Correlation ID IE and the SIPTO Correlation ID IE are mutually exclusive, i.e. they may not be sent together for the same E-RAB. If this should happen anyway, e.g. due to a faulty MME, the receiving RAN node may consider the establishment of that particular E-RAB as failed and initiates the appropriate error handling. Alternatively, if both IEs are present, the MME may decide to consider one of them as the valid one and to exclude the other. In the examples shown in Table 3 and Table 4, the semantics description implies that the MME will in some embodiments always consider the SIPTO Correlation ID IE as the valid IE in case both SIPTO Correlation ID IE and Correlation ID IE are present. In this case, the MME will ignore the Correlation ID IE.

An advantage of embodiments described herein, is that it is possible to support LIPA and SIPTO functionality operating over different E-RABs in the same RAN node at the same time, without ambiguity in the signaling. Certain embodiments may have specific advantages, e.g. depending on the deployment scenario and the desired mix of services by the operator.

A potential advantage of the first embodiment is that it requires no change whatsoever to S1AP signaling. It is therefore possible to implement LIPA and SIPTO functionality in the RAN node and keep the same legacy S1AP implementation. This embodiment also offers a certain degree of flexibility to the operator, since it is always possible to change the configured allocation of Correlation ID values between LIPA and SIPTO according to the need.

A potential advantage of the second and third embodiment is that it is not necessary to plan and pre-configure different Correlation ID values or ranges beforehand for either functionality, since explicit signaling is introduced. The whole range of possible values for the Correlation ID may be reused for both LIPA and SIPTO functionalities at the same time.

An additional advantage of the third embodiment may be that the SIPTO Correlation ID is completely independent from the Correlation ID, so in principle it may even be defined over a completely different range if required.

Some embodiments herein will now be further described.

According to an aspect, there is provided a method in a first network node for managing a radio access bearer, which is illustrated by the flow chart in FIG. 4. In this method, the first network node sends, in action 402, to a second network node, a first message comprising instructions for setting up the radio access bearer. The first message may comprise an INITIAL CONTEXT SETUP REQUEST message and/or an E-RAB SETUP REQUEST message in case of E-UTRAN. The first message, or the INITIAL CONTEXT SETUP REQUEST message and the E-RAB SETUP REQUEST message, may comprise an indication about SIPTO operation for the radio access bearer. The indication may be a flag, such as SIPTO Flag. Alternatively, the indication may be identification, such as a SIPTO Correlation Identification, ID.

Moreover, the first network node may receive, in action 403, a second message from the second network node indicating successful set up of the radio access bearer. The second message may comprise an E-RAB SETUP RESPONSE message and/or an INITIAL CONTEXT SETUP RESPONSE message. Thereby, the first network node manages the radio access bearer in that the radio access bearer has been successfully set up.

According to another aspect, there is provided a first network node configured to perform the method above, see FIG. 6.

According to a further aspect, there is provided a method in a second network node for managing a radio access bearer, which is illustrated by the flow chart in FIG. 5. In this latter method, the second network node receives from a first network node, in action 502, a first message comprising instructions for setting up the radio access bearer. Possible examples of the first message were described in the preceding section relating to the method in the first network node.

The second network node may execute the instructions for setting up the radio access bearer.

Moreover, the second network node may send to the first network node, in action 503, a second message indicating successful set up. Possible examples of the second message were described in the preceding section relating to the method in the first network node.

According to yet another aspect, there is provided a second network node configured to perform the method above, see FIG. 6.

According to an aspect, there is provided a method in a first network node, such as an OAM, for configuring a range of identifications, such as Correlation ID which is known from 3GPP specifications. The range of identification comprises a first sub-range for identifications relating to SIPTO and a second sub-range for identifications relating to LIPA.

In this latter method, the first network node sends a configuration message to the second network node. Moreover, the first network node may receive a further configuration message indicating successful configuration of the range of identifications.

According to a still further aspect, there is provided a first network node configured to perform the method above.

In a possible embodiment of the method in the first network node, the first network node comprises an MME and/or an OAM, wherein the first message comprises the configuration message and the second message comprises the further configuration message.

A detailed but non-limiting example of how a first network node and a second network node may be configured to accomplish the above-described examples and embodiments, is illustrated by the block diagram in FIG. 6.

The first network node 110 comprises a sending unit 115 adapted to send a first message comprising instructions for setting up the radio access bearer, to the second network node 120. The first network node 110 also comprises a receiving unit 116 adapted to receive a second message indicating successful set up of the radio access bearer, from the second network node 120.

The second network node 120 comprises a receiving unit 126 adapted to receive a first message comprising instructions for setting up the radio access bearer, from the first network node 110. The second network node 120 also comprises a sending unit 125 adapted to send a second message indicating successful set up of the radio access bearer, to the first network node 110.

The above first and second network nodes 110, 120 and their functional units 115, 116, and 125, 126 respectively, may be configured or adapted to operate according to various optional embodiments e.g. to implement any of the above-described embodiments of the methods in FIGS. 4 and 5.

It should be noted that FIG. 6 illustrates various functional units in the network nodes 110, 120 and the skilled person is able to implement these functional units in practice using suitable software and hardware. Thus, the solution is generally not limited to the shown structures of the network nodes 110, 120, and the functional units 115, 116, and 125, 126, respectively, may be configured to operate according to any of the features described in this disclosure, where appropriate.

The functional units 115, 116, 125 and 126 described above may be implemented in the respective network nodes 110, 120 by means of program modules of a respective computer program comprising code means which, when run by a processor “P” in each node 110, 120 cause the network nodes 110, 120 to perform the above-described actions and procedures. The processor P in each node 110, 120 may comprise a single Central Processing Unit (CPU), or could comprise two or more processing units. For example, the processor P in each node 110, 120 may comprise a general purpose microprocessor, an instruction set processor and/or related chips sets and/or a special purpose microprocessor such as an Application Specific Integrated Circuit (ASIC). The processor P in each node 110, 120 may also comprise a storage for caching purposes.

Each computer program may be carried by a computer program product in the network nodes 110, 120 in the form of a memory “M” having a computer readable medium and being connected to the processor P in each node 110, 120. The computer program product or memory M in each node 110, 120 thus comprises a computer readable medium on which the computer program is stored e.g. in the form of computer program modules “m”. For example, the memory M in each node 110, 120 may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the network nodes 110, 120.

While the solution has been described with reference to specific exemplary embodiments, the description is generally only intended to illustrate the inventive concept and should not be taken as limiting the scope of the solution.

Some embodiments herein may be described as follows:

According to an aspect, there is provided a method in a first network node for managing a radio access bearer. The first network node sends, to a second network node, a first message comprising instructions for setting up the radio access bearer. The first message may comprise an INITIAL CONTEXT SETUP REQUEST message and/or an E-RAB SETUP REQUEST message in case of E-UTRAN. The first message, or the INITIAL CONTEXT SETUP REQUEST message and the E-RAB SETUP REQUEST message, may comprise an indication about SIPTO operation for the radio access bearer. The indication may be a flag, such as SIPTO Flag. Alternatively, the indication may be identification, such as a SIPTO Correlation Identification (ID).

Moreover, the first network node may receive a second message indicating successful set up of the radio access bearer. The second message may comprise an E-RAB SETUP RESPONSE message and/or an INITIAL CONTEXT SETUP RESPONSE message. Thereby, the first network node manages the radio access bearer in that SIPTO operation for the radio access bearer has been successfully set up.

According to another aspect, there is provided a first network node configured to perform the method above.

According to a further aspect, there is provided a method in a second network node for managing a radio access bearer.

The second network node receives, from a first network node, a first message comprising instructions for setting up the radio access bearer. The first message is described in the preceding section relating to the method in the first network node.

The second network node may execute the instructions for setting up the radio access bearer. As an example, the SIPTO operation for the radio access bearer may be set up.

Moreover, the second network node may send, to the first network node, a second message indicating successful set up. The second messaged is described in the preceding section relating to the method in the first network node.

According to yet another aspect, there is provided a second network node configured to perform the method above.

According to a still other aspect, there is provided a method in a first network node, such as an OAM, for configuring a range of identifications, such as Correlation ID which is known from 3GPP specifications. The range of identification comprises a first sub-range for identifications relating to SIPTO and a second sub-range for identifications relating to LIPA.

The first network node sends a configuration message to the second network node.

Moreover, the first network node may receive a further configuration message indicating successful configuration of the range of identifications.

According to a still further aspect, there is provided a first network node configured to perform the method above.

In an embodiment of the method in the first network node, the first network node comprises an MME and/or an OAM, wherein the first message comprises the configuration message and the second message comprises the further configuration message.

Hence, in some embodiments, the second network node supports radio access bearers for both LIPA operation, SIPTO operation, and maybe also SIPTO at Local Network (LN).

The radio access bearer may be a Radio Access Bearer (RAB), an Evolved-RAB (E-RAB) or the like. The radio access bearer may provide a communication link between a UE, served by the second network node, and a gateway towards a wide area network, such as the Internet in case of SIPTO.

The messages with names in capital letters are known from standard specifications of the 3GPP.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

### ABBREVIATIONS

3GPP 3rd Generation Partnership Project
APN Access Point Name
eNB enhanced Node B
E-RAB E-UTRAN Radio Access Bearer
E-UTRAN Evolved Universal Terrestrial Radio Access Network
LIPA Local IP Access
L-GW Local Gateway
HeNB Home eNB
HeNB-GW HeNB Gateway
HSS Home Subscriber Server
MME Mobility Management Entity
RAN Radio Access Network
SIPTO Selective IP Traffic Offload
SIPTO@LN SIPTO at the Local Network
S1AP S1 Application Protocol
UE User Equipment
UTRAN Universal Terrestrial Radio Access Network

1-28. (canceled)

29. A method in a first network node for managing a radio access bearer between a local gateway and a user equipment served by a second network node, the method comprising:
sending to the second network node, a first message comprising an indication to set up the radio access bearer to be offloaded through a Selective Internet Protocol Traffic Offload (SIPTO) gateway as the local gateway,
which first message comprises a Correlation Identifier (ID) Information Element (IE).

30. The method of claim 29, wherein the Correlation ID IE is a SIPTO Correlation ID IE, and wherein the indication is represented by a SIPTO Correlation ID included in the SIPTO Correlation ID IE.

31. The method of claim 29, wherein the indication is represented by a SIPTO flag comprised in a SIPTO flag IE in the first message.

32. The method of claim 29, further comprising:
configuring a Correlation ID range comprising a first sub-range for identifications relating to SIPTO and a second sub-range for identifications relating to Local Internet Protocol Access (LIPA),
wherein the indication is represented by a Correlation ID from the first sub-range, included in the Correlation ID IE.

33. The method of claim 29, wherein the first message is represented by an INITIAL CONTEXT SETUP REQUEST message or an E-RAB SETUP REQUEST message, or both.

34. The method of claim 29, further comprising receiving a second message from the second network node, the second message indicating successful set up of the radio access bearer.

35. The method of claim 34, wherein the second message is represented by an E-RAB SETUP RESPONSE message or an INITIAL CONTEXT SETUP RESPONSE message, or both.

36. A method in a second network node for managing a radio access bearer between a local gateway and a user equipment served by the second network node, the method comprising:
receiving from a first network node, a first message comprising an indication to set up the radio access bearer to be offloaded through a Selective Internet Protocol Traffic Offload (SIPTO) gateway as the local gateway,
which first message comprises a Correlation Identifier (ID) Information Element (IE).

37. The method of claim 36, wherein the Correlation ID IE is a SIPTO Correlation ID IE, and wherein the indication is represented by a SIPTO Correlation ID, comprised in the SIPTO Correlation ID IE.

38. The method of claim 36, wherein the indication is represented by a SIPTO flag comprised in a SIPTO flag IE in the first message.

39. The method of claim 36, further comprising:
configuring a Correlation ID range comprising a first sub-range for identifications relating to SIPTO and a second sub-range for identifications relating to Local Internet Protocol Access (LIPA),
wherein the indication is represented by a Correlation ID from the first sub-range, included in the Correlation ID IE.

40. The method of claim 36, wherein the first message is represented by an INITIAL CONTEXT SETUP REQUEST message and/or an E-RAB SETUP REQUEST message.

41. The method of claim 36, further comprising sending a second message to the first network node, the second message indicating successful set up of the radio access bearer.

42. The method of claim 41, wherein the second message is represented by an E-RAB SETUP RESPONSE message or an INITIAL CONTEXT SETUP RESPONSE message, or both.

43. A first network node for managing a radio access bearer between a local gateway and a user equipment served by a second network node, the first network node comprising:
a sending circuit adapted to send to the second network node a first message comprising an indication to set up the radio access bearer to be offloaded through a Selective Internet Protocol Traffic Offload (SIPTO) gateway as the local gateway,
which first message comprises a Correlation Identifier (ID) Information Element (IE).

44. The first network node of claim 43, wherein the Correlation ID IE is a SIPTO Correlation ID IE, and wherein the indication is represented by a SIPTO Correlation ID, comprised in the SIPTO Correlation ID IE.

45. The first network node of claim 43, wherein the indication is represented by a SIPTO flag comprised in a SIPTO flag IE in the first message.

46. The first network node of claim 43, further comprising:
a processor arranged to configure a Correlation ID range comprising a first sub-range for identifications relating to SIPTO and a second sub-range for identifications relating to Local Internet Protocol Access (LIPA),
wherein the indication is represented by a Correlation ID from the first sub-range, included in the Correlation ID IE.

47. The first network node of claim 43, wherein the first message is represented by an INITIAL CONTEXT SETUP REQUEST message or an E-RAB SETUP REQUEST message, or both.

48. The first network node of claim 43, further comprising a receiving unit adapted to receive a second message from the second network node, indicating successful set up of the radio access bearer.

49. The first network node of claim 48, wherein the second message is represented by an E-RAB SETUP RESPONSE message or an INITIAL CONTEXT SETUP RESPONSE message, or both.

50. A second network node for managing a radio access bearer between a local gateway and a user equipment served by the second network node, the second network node comprising:
a receiving circuit adapted to receive from a first network node, a first message comprising an indication to set up the radio access bearer to be offloaded through a Selective Internet Protocol Traffic Offload (SIPTO) gateway as the local gateway,
which first message comprises a Correlation Identifier (ID) Information Element (IE).

51. The second network node of claim 50, wherein the Correlation ID IE is a SIPTO Correlation ID IE, and wherein the indication is represented by a SIPTO Correlation ID, comprised in the SIPTO Correlation ID IE.

52. The second network node of claim 50, wherein the indication is represented by a SIPTO flag comprised in a SIPTO flag IE in the first message.

53. The second network node of claim 50, further comprising:
a processor arranged to configure a Correlation ID range comprising a first sub-range for identifications relating to SIPTO and a second sub-range for identifications relating to Local Internet Protocol Access (LIPA),
wherein the indication is represented by a Correlation ID from the first sub-range, included in the Correlation ID IE.

54. The second network node of claim 50, wherein the first message is represented by an INITIAL CONTEXT SETUP REQUEST message or an E-RAB SETUP REQUEST message.

55. The second network node of claim 50, further comprising a sending unit adapted to send a second message to the first network node, indicating successful set up of the radio access bearer.

56. The second network node of claim 55, wherein the second message is represented by an E-RAB SETUP RESPONSE message and/or an INITIAL CONTEXT SETUP RESPONSE message.
